(19) United States
(12) Patent Application Publication
(10) Pub. No.: US 2026/0299365 A1
(43) Pub. Date: Oct. 1, 2026

(54) ELECTROCHROMIC DEVICE, METHOD OF MANUFACTURING SAME AND WINDOW DEVICE INCLUDING SAME

(71) Applicant: SKC CO., LTD., Gyeonggi-do (KR)

(72) Inventors: Byeonguk AHN, Gyeonggi-do (KR); Yongsang LA, Gyeonggi-do (KR); Seonghwan LEE, Gyeonggi-do (KR); Seungbae OH, Gyeonggi-do (KR)

(21) Appl. No.: 19/577,387

(22) Filed: Mar. 25, 2026

(30) Foreign Application Priority Data
Mar. 25, 2025 (KR) 10-2025-0038148

(51) Int. Cl. G02F 1/1523; G02F 1/1524; G02F 1/153

(52) U.S. Cl. CPC G02F 1/1525; G02F 1/1524; G02F 1/1533

(57) ABSTRACT

The embodiment provides an electrochromic device comprising: a first substrate; a first transparent electrode disposed on the first substrate; a first chromic layer disposed on the first transparent electrode; an electrolyte layer disposed on the first chromic layer; a second chromic layer disposed on the electrolyte layer; a second transparent electrode disposed on the second chromic layer; a second substrate disposed on the second transparent electrode; and a lithium-rich layer disposed under and adjacent to the second chromic layer, wherein the lithium-rich layer contains lithium at a higher concentration than the second chromic layer.

### CROSS-REFERENCE TO RELATED APPLICATION

This application claims priority under 35 U.S.C. § 119 to Korean Patent Application No. 10-2025-0038148 filed on Mar. 25, 2025, which is incorporated herein by reference in its entirety.

### TECHNOLOGY FIELD

The embodiment relates to an electrochromic device, a method for manufacturing the same and a window device including the same.

### BACKGROUND TECHNOLOGY OF THE INVENTION

Electrochromic films are films that change color by undergoing redox reactions at each oxidation electrode and reduction electrode depending on the applied potential. They are films that can be artificially controlled by the user to control visible light and infrared rays, and various types of inorganic oxides are used as electrode materials.

As described above, various electrochromic films have been developed and patented. Looking at the contents of the patent applications, Korean Patent Publication No. 2001-0087586 discloses a film in which MoO3, a reduced chromogenic oxide, is deposited on one of two ITO films (1A, 1B) in which an indium-tin oxide thin film having conductivity is deposited on a glass film, and WO₃, also a reduced chromogenic material, is deposited on the other, and then a solid electrolyte of lithium, an alkali metal, is deposited thereon, and polyaniline, a conductive polymer, is placed between the two films, and when voltage is applied by passing it through a high-frequency compression roller, the film changes from transparent to blue, and Korean Utility Model Publication No. 0184841 discloses a film in which indium-tin oxide is deposited on a 0.05 mm thick glass film, and then WO₃, a reduced chromogenic material, and IrO₂, an oxidized chromogenic material, are deposited with an α-PEO copolymer, a polymer solid electrolyte, in between. A color-changing film by electric energy is known, characterized by being bonded to both sides of a transition metal oxide film by a high-frequency roller.

### CONTENTS OF THE INVENTION

### The Task to be Solved

The embodiment provides an electrochromic device having improved durability and color change speed, a method for manufacturing the same, and a window device including the same.

### MEANS OF SOLVING THE PROBLEM

An electrochromic device according to an embodiment includes: a first substrate; a first transparent electrode disposed on the first substrate; a first chromic layer disposed on the first transparent electrode; an electrolyte layer disposed on the first chromic layer; a second chromic layer disposed on the electrolyte layer; a second transparent electrode disposed on the second chromic layer; a second substrate disposed on the second transparent electrode; and a lithium-rich layer disposed under and adjacent to the second chromic layer, wherein the lithium concentration of the lithium-rich layer is higher than the lithium concentration of the second chromic layer.

In an embodiment, the lithium concentration of the second chromic layer may gradually decrease as the second chromic layer approaches the second transparent electrode from the lithium-rich layer.

In an embodiment, the lithium-rich layer may include lithium hydroxide.

In an embodiment, the first substrate and the second substrate may be flexible.

In an embodiment, the lithium-rich layer may have a thickness of 10 nm to 1000 nm.

In an embodiment, the first chromic layer may include tungsten oxide, and the second chromic layer may include nickel oxide.

In an embodiment, the lithium-rich layer may include lithium at a higher concentration than the electrolyte layer.

In an embodiment, the lithium concentration of the lithium-rich layer may be 3 to 30 times higher than the lithium concentration of the second chromic layer.

A method for manufacturing an electrochromic device according to one embodiment comprises preparing a first laminate comprising a first substrate, a first transparent electrode on the first substrate and a first chromic layer on the first transparent electrode; preparing a second laminate comprising a second substrate, a second transparent electrode on the second substrate, a second chromic layer on the second transparent electrode, and a lithium-rich layer on the second chromic layer; and bonding the first laminate and the second laminate via an electrolyte layer, wherein the lithium-rich layer contains lithium at a higher concentration than the second chromic layer.

In a method for manufacturing an electrochromic device according to one embodiment, the step of preparing the second laminate may include a step of coating lithium hydrate on the second chromic layer.

In a method for manufacturing an electrochromic device according to one embodiment, the step of preparing the second laminate may further include a step of heat-treating the lithium hydroxide.

In a method for manufacturing an electrochromic device according to one embodiment, the lithium concentration of the second chromic layer may gradually decrease as it approaches the second transparent electrode from the lithium-rich layer.

In a method for manufacturing an electrochromic device according to one embodiment, in the step of heat-treating the lithium hydroxide, the lithium included in the lithium hydroxide may diffuse into the second chromic layer.

A window device according to an embodiment includes a frame; a window mounted on the frame; and an electrochromic device disposed on the window, wherein the electrochromic device includes a first substrate; a first transparent electrode disposed on the first substrate; a first chromic layer disposed on the first transparent electrode; an electrolyte layer disposed on the first chromic layer; a second chromic layer disposed on the electrolyte layer; a second transparent electrode disposed on the second chromic layer; a second substrate disposed on the second transparent electrode; and a lithium-rich layer disposed beneath and adjacent to the second chromic layer, wherein the lithium-rich layer includes lithium at a higher concentration than the second chromic layer.

### Effect of Invention

An electrochromic device according to an embodiment includes a lithium-rich layer. Accordingly, the electrochromic device according to an embodiment can improve the movement speed of lithium ions during operation. Specifically, the lithium-rich layer can supply lithium ions to a second chromic layer and rapidly change the color of the second chromic layer.

Furthermore, the second chromic layer can have an increasingly higher lithium concentration as the second chromic layer approaches the lithium-rich layer. Accordingly, the electrochromic device according to an embodiment can improve the speed of the color change in the early stages of the color change.

Furthermore, because the second chromic layer is adjacent to the lithium-rich layer, the second chromic layer can contain a high concentration of lithium ions. That is, the second chromic layer can accommodate a high concentration of lithium ions.

Furthermore, because the second chromic layer is adjacent to the lithium-rich layer, the second chromic layer can receive a high concentration of lithium ions. Consequently, the second chromic layer can rapidly accommodate a high concentration of lithium ions. Accordingly, the second chromic layer can rapidly discolor with an appropriate color and appropriate transmittance.

Therefore, the electrochromic device according to the embodiment can have improved discoloration speed and discoloration performance.

Furthermore, since the lithium contained in the lithium-rich layer gradually diffuses into the second chromic layer, the electrochromic device according to the embodiment can easily color and decolor the second chromic layer.

Therefore, the electrochromic device according to the embodiment can reduce the chemical impact applied to the second chromic layer during the coloring and/or decoloring process.

Therefore, the electrochromic device according to the embodiment can reduce the operating time, reduce the discoloration impact, and have improved a durability.

### BRIEF DESCRIPTION OF THE DRAWING

FIG. 1 is a cross-sectional view illustrating a cross-section of an electrochromic device according to an embodiment.

FIGS. 2 to 5 are drawings illustrating a process for manufacturing an electrochromic device according to an embodiment.

FIG. 6 is a drawing illustrating a window device according to an embodiment.

### SPECIFIC DETAILS FOR CARRYING OUT THE INVENTION

In the description of the embodiments, when each part, surface, layer, or substrate is described as being formed “on” or “under” each part, surface, layer, or substrate, “on” and “under” include both “directly” and “indirectly” formed. Furthermore, the reference to “on” or “under” each component is described based on the drawings. The sizes of each component in the drawings may be exaggerated for illustrative purposes and do not necessarily represent actual sizes.

FIG. 1 is a cross-sectional view illustrating a cross-section of an electrochromic device according to an embodiment.

Referring to FIG. 1, the electrochromic device according to the embodiment includes a first substrate (100), a second substrate (200), a first transparent electrode (300), a second transparent electrode (400), a first chromic layer (500), a second chromic layer (600), a lithium-rich layer (700) and an electrolyte layer (800). The first substrate (100) supports, together with the second substrate (200), the first transparent electrode (300), the first chromic layer (500), the second chromic layer (600), the second transparent electrode (400), the lithium-rich layer (700) and the electrolyte layer (800).

Furthermore, the first substrate (100) sandwiches, together with the second substrate (200), the first transparent electrode (300), the first chromic layer (500), the second chromic layer (600), the lithium-rich layer (700), the second transparent electrode (400), and the electrolyte layer (800). The first substrate (100) can protect the first transparent electrode (300), the first chromic layer (500), the second chromic layer (600), the second transparent electrode (400), the lithium-rich layer (700), and the electrolyte layer (800) together with the second substrate (200) from external physical and chemical impacts.

The first substrate (100) may include a polymer resin. The first substrate (100) may include at least one selected from the group consisting of a polyester-based resin, a polyimide-based resin, a cyclic olefin polymer resin, polyethersulfone, polycarbonate, or a polyolefin-based resin.

The first substrate (100) may include a polyester resin as a main component. The first substrate (100) may include polyethylene terephthalate. The first substrate (100) may include the polyethylene terephthalate in an amount of about 90 wt % or more based on the total composition. The first substrate (100) may include the polyethylene terephthalate in an amount of about 95 wt % or more based on the total composition. The first substrate (100) may include the polyethylene terephthalate in an amount of about 97 wt % or more based on the total composition. The first substrate (100) may include the polyethylene terephthalate in an amount of about 98 wt % or more based on the total composition.

The first substrate (100) may include a uniaxially or biaxially stretched polyethylene terephthalate film. The first substrate (100) may include a polyethylene terephthalate film stretched about 2 to about 5 times in the longitudinal and/or transverse directions. The first substrate (100) may have high mechanical properties to reinforce the glass when applied to a window of a building or vehicle.

The first substrate (100) may have a tensile strength of about 7 kgf/mm′ to about 40 kgf/mm′ in the longitudinal direction. The first substrate (100) may have a tensile strength of about 8 kgf/mm′ to about 35 kgf/mm′ in the longitudinal direction.

The first substrate (100) may have a tensile strength of about 7 kgf/mm′ to about 40 kgf/mm′ in the width direction. The first substrate (100) may have a tensile strength of about 8 kgf/mm′ to about 35 kgf/mm′ in the width direction. The first substrate (100) may have a modulus of about 200 kgf/mm² to about 400 kgf/mm² in the longitudinal direction. The first substrate (100) may have a modulus of about 250 kgf/mm² to about 350 kgf/mm² in the longitudinal direction. The first substrate (100) may have a modulus of about 250 kgf/mm² to about 270 kgf/mm² in the longitudinal direction.

The first substrate (100) may have a modulus of about 200 kgf/mm² to about 400 kgf/mm² in the width direction. The first substrate (100) may have a modulus of about 250 kgf/mm² to about 350 kgf/mm² in the width direction. The first substrate (100) may have a modulus of about 250 kgf/mm² to about 270 kgf/mm² in the width direction.

The first substrate (100) may have a breaking elongation of about 30% to about 150% in the longitudinal direction. The first substrate (100) may have a breaking elongation of about 30% to about 130% in the longitudinal direction. The first substrate (100) may have a breaking elongation of about 40% to about 120% in the longitudinal direction.

The first substrate (100) may have a breaking elongation of about 30% to about 150% in the longitudinal direction. The first substrate (100) may have a breaking elongation of about 30% to about 130% in the longitudinal direction. The first substrate (100) may have a breaking elongation of about 40% to about 120% in the longitudinal direction.

The first substrate (100) may have a breaking elongation of about 30% to about 150% in the width direction. The first substrate (100) may have a breaking elongation of about 30% to about 130% in the width direction. The first substrate (100) may have a breaking elongation of about 40% to about 120% in the width direction.

The modulus, the breaking elongation, and the tensile strength may be measured according to KS B 5521.

In addition, the modulus, the tensile strength, and the breaking elongation may be measured according to ASTM D882. Since the first substrate (100) has the improved mechanical strength described above, the first substrate (100) can effectively protect the first transparent electrode (300), the second transparent electrode (400), the first chromic layer (500), the second chromic layer (600), and the electrolyte layer (800). Furthermore, since the first substrate (100) has the improved mechanical strength described above, the first substrate (100) can effectively reinforce the mechanical strength of the glass to which the first substrate (100) is to be attached.

Furthermore, the first substrate (100) can have high chemical resistance. Accordingly, even if the electrolyte contained in the electrolyte leaks onto the first substrate (100), damage to the surface of the first substrate (100) can be minimized.

The first substrate (100) can have improved optical properties. The total light transmittance of the first substrate (100) can be approximately 55% or greater. The total light transmittance of the first substrate (100) may be about 70% or greater. The total light transmittance of the first substrate (100) may be about 75% to about 99%. The total light transmittance of the first substrate (100) may be about 80% to about 99%.

The haze of the first substrate (100) may be less than about 20%. The haze of the first substrate (100) may be about 0.1% to about 20%. The haze of the first substrate (100) may be about 0.1% to about 10%. The haze of the first substrate (100) may be about 0.1% to about 7%.

The total light transmittance and the haze may be measured according to ASTM D 1003, etc. Since the first substrate (100) has appropriate total light transmittance and haze, the electrochromic device according to the embodiment can have improved optical properties. That is, since the first substrate (100) has appropriate transmittance and haze, the electrochromic device according to the embodiment can be applied to a window, and can minimize image distortion from the outside while appropriately controlling the transmittance, and have an improved appearance.

Furthermore, the first substrate (100) can have an in-plane retardation of about 100 nm to about 4000 nm. The first substrate (100) can have an in-plane retardation of about 200 nm to about 3500 nm. The first substrate (100) can have an in-plane retardation of about 200 nm to about 3000 nm.

The first substrate (100) can have an in-plane retardation of about 7000 nm or more. The first substrate (100) may have an in-plane retardation of about 7,000 nm to about 50,000 nm. The first substrate (100) may have an in-plane retardation of about 8,000 nm to about 20,000 nm.

The in-plane retardation may be derived from the refractive index along the direction of the first substrate (100) and thickness of the first substrate (100).

Because the first substrate (100) has the in-plane retardation described above, the electrochromic film according to the embodiment may have an improved appearance.

The thickness of the first substrate (100) may be about 10 μm to about 200 μm. The thickness of the first substrate (100) may be about 23 μm to about 150 μm. The thickness of the first substrate (100) may be about 30 μm to about 120 μm. The first substrate (100) may include an organic or inorganic filler. The organic or inorganic filler may function as an anti-blocking agent.

The average particle diameter of the filler may be about 0.1 μm to about 5 μm. The average particle diameter of the filler may be about 0.1 μm to about 3 μm. The average particle diameter of the filler may be about 0.1 μm to about 1 μm.

The filler may be selected from the group consisting of silica particles, barium sulfate particles, alumina particles, or titania particles.

Furthermore, the filler may be included in the first substrate (100) in an amount of about 0.01 wt % to about 3 wt % based on the entire first substrate (100). The filler may be included in the first substrate (100) in an amount of about 0.05 wt % to about 2 wt % based on the entire first substrate (100).

The first substrate (100) may have a single-layer structure.

There is. For example, the first substrate (100) may be a single-layer polyester film.

The first substrate (100) may have a multilayer structure. For example, the first substrate (100) may be a multilayer coextruded film. The multilayer coextruded structure may include an intermediate layer, a first surface layer, and a second surface layer. The filler may be included in the first surface layer and the second surface layer.

The second substrate (200) faces the first substrate (100). The second substrate (200) is disposed on the first substrate (100). One end of the second substrate (200) may be disposed to be misaligned with one end of the first substrate (100). The other end of the second substrate (200) may be arranged to be misaligned with the other end of the first substrate (100).

The second substrate (200) supports, together with the first substrate (100), the first transparent electrode (300), the first chromic layer (500), the second chromic layer (600), the second transparent electrode (400), the lithium-rich layer (700) and the electrolyte layer (800). In addition, the second substrate (200) sandwiches, together with the first substrate (100), the first transparent electrode (300), the first chromic layer (500), the second chromic layer (600), the second transparent electrode (400), the lithium-rich layer (700), and the electrolyte layer (800). The second substrate (200) can protect the first transparent electrode (300), the first chromic layer (500), the second chromic layer (600), the second transparent electrode (400), the lithium-rich layer (700), and the electrolyte layer (800) together with the first substrate (100) from external physical and chemical impacts.

The second substrate (200) may include a polymer resin. The second substrate (200) may include at least one selected from the group consisting of a polyester-based resin, a polyimide-based resin, a cyclic olefin polymer resin, polyethersulfone, polycarbonate or a polyolefin-based resin.

The second substrate (200) may include a polyester resin as a main component. The second substrate (200) may include polyethylene terephthalate. The second substrate (200) may include the polyethylene terephthalate in an amount of about 90 wt % or more based on the total composition. The second substrate (200) may include the polyethylene terephthalate in an amount of about 95 wt % or more based on the total composition. The second substrate (200) may include the polyethylene terephthalate in an amount of about 97 wt % or more based on the total composition. The second substrate (200) may include the polyethylene terephthalate in an amount of about 98 wt % or more based on the total composition.

The second substrate (200) may include a uniaxially or biaxially stretched polyethylene terephthalate film. The second substrate (200) may include a polyethylene terephthalate film stretched about 2 to about 5 times in the longitudinal and/or transverse directions. The second substrate (200) may have high mechanical properties to reinforce the glass when applied to a window of a building or vehicle.

The second substrate (200) may have a tensile strength of about 7 kgf/mm² to about 40 kgf/mm² in the longitudinal direction. The second substrate (200) may have a tensile strength of about 8 kgf/mm² to about 35 kgf/mm² in the longitudinal direction.

The second substrate (200) may have a tensile strength of about 7 kgf/mm² to about 40 kgf/mm² in the width direction. The second substrate (200) may have a tensile strength of about 8 kgf/mm² to about 35 kgf/mm² in the width direction. The second substrate (200) may have a modulus of about 200 kgf/mm² to about 400 kgf/mm² in the longitudinal direction. The second substrate (200) may have a modulus of about 250 kgf/mm² to about 350 kgf/mm² in the longitudinal direction. The second substrate (200) may have a modulus of about 250 kgf/mm² to about 270 kgf/mm² in the longitudinal direction.

The second substrate (200) may have a modulus of about 200 kgf/mm² to about 400 kgf/mm² in the width direction. The second substrate (200) may have a modulus of about 250 kgf/mm² to about 350 kgf/mm² in the width direction. The second substrate (200) may have a modulus of about 250 kgf/mm² to about 270 kgf/mm² in the width direction.

The second substrate (200) may have a breaking elongation of about 30% to about 150% in the longitudinal direction. The second substrate (200) may have a breaking elongation of about 30% to about 130% in the longitudinal direction. The second substrate (200) may have a breaking elongation of about 40% to about 120% in the longitudinal direction.

The second substrate (200) may have a breaking elongation of about 30% to about 150% in the longitudinal direction. The second substrate (200) may have a breaking elongation of about 30% to about 130% in the longitudinal direction. The second substrate (200) may have a breaking elongation of about 40% to about 120% in the longitudinal direction.

The second substrate (200) may have a breaking elongation of about 30% to about 150% in the width direction. The second substrate (200) may have a breaking elongation of about 30% to about 130% in the width direction. The second substrate (200) may have a breaking elongation of about 40% to about 120% in the width direction.

Since the second substrate (200) has the improved mechanical strength described above, it can effectively protect the first transparent electrode (300), the second transparent electrode (400), the first chromic layer (500), the second chromic layer (600), and the electrolyte layer (800). Furthermore, since the second substrate (200) has the improved mechanical strength described above, it can effectively reinforce the mechanical strength of the glass to which it is to be attached.

Furthermore, the second substrate (200) can have high chemical resistance. Accordingly, even if the electrolyte contained in the electrolyte leaks onto the second substrate (200), damage to the surface of the second substrate (200) can be minimized.

The second substrate (200) can have improved optical properties. The total light transmittance of the second substrate (200) can be about 55% or greater. The total light transmittance of the second substrate (200) can be about 70% or greater. The total light transmittance of the second substrate (200) can be about 75% to about 99%. The total light transmittance of the second substrate (200) can be about 80% to about 99%. The haze of the second substrate (200) may be less than about 20%. It may be about 0.1% to about 20%. The haze of the second substrate (200) may be about 0.1% to about 10%. The haze of the second substrate (200) may be about 0.1% to about 7%.

Because the second substrate (200) has appropriate total light transmittance and haze, the electrochromic device according to the embodiment may have improved optical properties. That is, because the second substrate (200) has appropriate transmittance and haze, the electrochromic device according to the embodiment may be applied to a window, appropriately controlling transmittance while minimizing image distortion from the outside and providing an improved appearance.

In addition, the second substrate (200) may have an in-plane phase difference of about 100 nm to about 4,000 nm. The second substrate (200) may have an in-plane retardation of about 200 nm to about 3,500 nm. The second substrate (200) may have an in-plane retardation of about 200 nm to about 3,000 nm.

The second substrate (200) may have an in-plane retardation of about 7,000 nm or more. The second substrate (200) may have an in-plane retardation of about 7,000 nm to about 50,000 nm. The second substrate (200) may have an in-plane retardation of about 8,000 nm to about 20,000 nm.

The in-plane retardation may be derived from the refractive index along the direction of the second substrate and thickness of the second substrate (200).

Because the second substrate (200) has the in-plane retardation as described above, the electrochromic device according to the embodiment may have an improved appearance. The thickness of the second substrate (200) may range from about 10 μm to about 200 μm. The thickness of the first substrate (100) may range from about 23 μm to about 150 μm. The thickness of the first substrate (100) may range from about 30 μm to about 120 μm.

The second substrate (200) may include an organic or inorganic filler. The organic or inorganic filler may function as an anti-blocking agent.

The average particle diameter of the filler may range from about 0.1 μm to about 5 μm. The average particle diameter of the filler may range from about 0.1 μm to about 3 μm. The average particle diameter of the filler may range from about 0.1 μm to about 1 μm.

The filler may be selected from at least one selected from the group consisting of silica particles, barium sulfate particles, alumina particles, or titania particles. Additionally, the filler may be included in the second substrate (200) in an amount of about 0.01 wt % to about 3 wt % based on the entire second substrate (200). The filler may be included in the second substrate (200) in an amount of about 0.05 wt % to about 2 wt % based on the entire second substrate (200).

The second substrate (200) may have a single-layer structure. For example, the second substrate (200) may be a single-layer polyester film.

The second substrate (200) may have a multi-layer structure. For example, the second substrate (200) may be a multi-layer co-extruded film.

The first substrate (100) and the second substrate (200) may be flexible. Accordingly, the electrochromic device according to the embodiment may be flexible overall.

The first transparent electrode (300) is disposed on the first substrate (100). The first transparent electrode (300) may be formed by being deposited on the first substrate (100). In addition, a hard coating layer may be further included between the first transparent electrode (300) and the first substrate (100). The first transparent electrode (300) may include at least one selected from the group consisting of tin oxide, zinc oxide, silver (Ag), chromium (Cr), indium tin oxide (ITO), fluorine doped tin oxide (FTO), aluminum doped zinc oxide (AZO), gallium doped zinc oxide (GZO), antimony doped tin oxide (ATO), indium zinc oxide (IZO), niobium doped titanium oxide (NTO), or cadmium tin oxide (CTO). Additionally, the first transparent electrode (300) may include graphene, silver nanowires, and/or a metal mesh.

The first transparent electrode (300) may have a total light transmittance of about 80% or greater. The first transparent electrode (300) may have a total light transmittance of about 85% or greater. The first transparent electrode (300) may have a total light transmittance of about 88% or greater.

The first transparent electrode (300) may have a haze of less than about 10%. The first transparent electrode (300) may have a haze of less than about 7%. The first transparent electrode (300) may have a haze of less than about 5%.

The sheet resistance of the first transparent electrode (300) may be about 1 Ω/sq to 600/sq. The sheet resistance of the first transparent electrode (300) may be approximately 12 Ω/sq to 400 Ω/sq. The sheet resistance of the first transparent electrode (300) may be approximately 1 Ω/sq to 30 Ω/sq.

The thickness of the first transparent electrode (300) may be approximately 50 nm to approximately 50 μm. The thickness of the first transparent electrode (300) may be approximately 100 nm to approximately 10 μm. The thickness of the first transparent electrode (300) may be approximately 150 nm to approximately 5 μm.

The first transparent electrode (300) is electrically connected to the first chromic layer (500). Furthermore, the first transparent electrode (300) is electrically connected to the electrolyte layer (800) through the first chromic layer (500). The second transparent electrode (400) is disposed under the second substrate (200). The second transparent electrode (400) may be formed by deposition on the second substrate (200). In addition, a hard coating layer may be further included between the second transparent electrode (400) and the second substrate (200). The second transparent electrode (400) may include at least one selected from the group consisting of tin oxide, zinc oxide, silver (Ag), chromium (Cr), indium tin oxide (ITO), fluorine doped tin oxide (FTO), aluminum doped zinc oxide (AZO), gallium doped zinc oxide (GZO), antimony doped tin oxide (ATO), indium zinc oxide (IZO), niobium doped titanium oxide (NTO), or cadmium tin oxide (CTO). Additionally, the second transparent electrode (400) may include graphene, silver nanowires, and/or metal mesh.

The second transparent electrode (400) may have a total light transmittance of about 80% or greater. The second transparent electrode (400) may have a total light transmittance of about 85% or greater. The second transparent electrode (400) may have a total light transmittance of about 88% or greater.

The second transparent electrode (400) may have a haze of less than about 10%. The second transparent electrode (400) may have a haze of less than about 7%. The second transparent electrode (400) may have a haze of less than about 5%.

The sheet resistance of the second transparent electrode (400) may be about 1 Ω/sq to 60 Ω/sq. The sheet resistance of the second transparent electrode (400) may be approximately 1 Ω/sq to 40 Ω/sq. The sheet resistance of the second transparent electrode (400) may be approximately 1 Ω/sq to 300/sq.

The thickness of the second transparent electrode (400) may be approximately 50 nm to approximately 50 μm. The thickness of the second transparent electrode (400) may be approximately 100 nm to approximately 10 μm. The thickness of the second transparent electrode (400) may be approximately 150 nm to approximately 5 μm.

The second transparent electrode (400) is electrically connected to the second chromic layer (600). Furthermore, the second transparent electrode (400) is electrically connected to the electrolyte layer (800) via the second chromic layer (600). The first chromic layer (500) is disposed on the first transparent electrode (300). The first chromic layer (500) may be directly disposed on the upper surface of the first transparent electrode (300). The first chromic layer (500) may be directly electrically connected to the first transparent electrode (300).

The first chromic layer (500) is electrically connected to the first transparent electrode (300). The first chromic layer (500) may be directly connected to the first transparent electrode (300). In addition, the first chromic layer (500) is electrically connected to the electrolyte layer (800). The first chromic layer (500) may be electrically connected to the electrolyte layer (800).

The first chromic layer (500) may be discolored or colored by receiving electrons. The first chromic layer (500) may include a first electrochromic material that changes color when supplied with electrons. The first electrochromic material may include at least one selected from the group consisting of tungsten oxide, niobium pentoxide, vanadium pentoxide, titanium oxide, molybdenum oxide, vilogen, and poly(3,4-ethylenedioxythiophene; PEDOT).

The first chromic layer (500) may include the first electrochromic material in the form of particles. The tungsten oxide, niobium pentoxide, vanadium pentoxide, titanium oxide, and molybdenum oxide may be particles having an average particle diameter of about 1 nm to about 200 nm. The average particle diameter of the first electrochromic material may be about 5 nm to about 100 nm. The average particle diameter of the first electrochromic material may be about 10 nm to about 50 nm.

The first chromic layer (500) may include the first electrochromic material in an amount of about 70 wt % to about 98 wt % based on the total weight of the first chromic layer (500). The first chromic layer (500) may include the first electrochromic material in an amount of about 80 wt % to about 96 wt % based on the total weight of the first chromic layer (500). The first chromic layer (500) may include the first electrochromic material in an amount of about 85 wt % to about 94 wt % based on the total weight of the first chromic layer (500). Since the first chromic layer (500) includes the first electrochromic material in the average particle diameter and weight range, the electrochromic device according to the embodiment may have improved optical and electrochromic characteristics.

In addition, the first chromic layer (500) may further include a binder. The binder may be an inorganic binder. The binder may include silica gel. The binder may be formed by a silica sol containing tetramethoxysilane or methyltrimethoxysilane.

The first chromic layer (500) may include the binder in an amount of about 1 wt % to 20 wt % based on the total weight of the first chromic layer (500). The first chromic layer (500) may include the binder in an amount of about 5 wt % to 15 wt % based on the total weight of the first chromic layer (500). The first chromic layer (500) may include the binder in an amount of about 7 wt % to 13 wt % based on the total weight of the first chromic layer (500).

The second chromic layer (600) is disposed under the second transparent electrode (400). The second chromic layer (600) may be directly disposed on the lower surface of the second transparent electrode (400). The second chromic layer (600) may be directly electrically connected to the second transparent electrode (400).

The second chromic layer (600) is electrically connected to the second transparent electrode (400). The second chromic layer (600) may be directly connected to the second transparent electrode (400). In addition, the second chromic layer (600) is electrically connected to the electrolyte layer (800). The second chromic layer (600) may be electrically connected to the electrolyte layer (800).

The second chromic layer (600) may be colored or discolored by losing electrons. The second chromic layer (600) may be oxidized by losing electrons. The second electrochromic material may be included. The second chromic layer (600) may include at least one selected from the group consisting of Prussian blue, nickel oxide, and iridium oxide.

The second chromic layer (600) may include the second electrochromic material in particle form. The Prussian blue, nickel oxide, and iridium oxide may be particles having a particle diameter of about 1 nm to about 200 nm.

In addition, the second chromic layer (600) may further include the binder.

In addition, the second chromic layer (600) may include lithium. The lithium may diffuse from the lithium-rich layer (700) to the second chromic layer (600), thereby forming the second electrochromic material.

Lithium ions may be injected into the second chromic layer (600) in the form of ions. That is, the second chromic layer (600) may include lithium ions. The lithium may be combined with the second electrochromic material and included in the second chromic layer (600).

In the second chromic layer (600), the concentration of the lithium ions may be about 0.1 wt % to about 10 wt %, about 0.5 wt % to about 15 wt %, about 0.1 wt % to about 5 wt %, about 0.1 wt % to about 3 wt %, or about 1 wt % to about 10 wt %.

Because the chromic layer includes the lithium in the above-described amount, it may have an improved chromic speed and improved durability. Additionally, in the second chromic layer (600), the concentration of lithium ions may gradually decrease from the lithium-rich layer (700) to the second transparent electrode. That is, in the second chromic layer (600), the concentration of lithium may gradually decrease toward the top.

In the second chromic layer (600), the difference between the concentration of lithium at the top and the concentration of lithium at the bottom may be about 0.1 wt % to about 5 wt %, about 0.3 wt % to about 3 wt %, about 0.5 wt % to about 5 wt %, about 1 wt % to about 10 wt %, or about 0.7 wt % to about 7 wt %. At the uppermost portion of the second chromic layer (600), the lithium concentration may be about 0 wt % to about 3 wt %, about 0 wt % to about 2 wt %, about 0 wt % to about 1.5 wt %, or about 0 wt % to about 1 wt %.

At the lowermost portion of the second chromic layer (600), the lithium concentration may be about 3 wt % to about 10 wt %, about 4 wt % to about 15 wt %, about 3 wt % to about 15 wt %, or about 5 wt % to about 10 wt %.

In the second chromic layer (600), the lithium concentration may be the initial concentration.

In addition, as described above, the second chromic layer (600) may include particles comprising the second electrochromic material. That is, the second chromic layer (600) may include electrochromic particles. The electrochromic particles may include the second electrochromic material.

In the electrochromic particles, the lithium concentration may gradually decrease from the outermost region to the center.

In the electrochromic particles, the difference between the lithium concentration at the center and the lithium concentration at the outermost region may be about 0.1 wt % to about 5 wt %, about 0.3 wt % to about 3 wt %, about 0.5 wt % to about 5 wt %, about 1 wt % to about 10 wt %, or about 0.7 wt % to about 7 wt %. At the center of the electrochromic particle, the lithium concentration may be about 0 wt % to about 3 wt %, about 0 wt % to about 2 wt %, about 0 wt % to about 1.5 wt %, or about 0 wt % to about 1 wt %.

At the outermost portion of the electrochromic particle, the lithium concentration may be about 3 wt % to about 10 wt %, about 4 wt % to about 15 wt %, about 3 wt % to about 15 wt %, or about 5 wt % to about 10 wt %.

Since the second chromic layer (600) includes lithium in the above-described amount, it may have improved discoloration speed and durability.

The lithium-rich layer (700) is disposed below the second chromic layer (600). The lithium-rich layer (700) may be adjacent to the lower surface of the second chromic layer (600). The lithium-rich layer (700) may be in direct contact with the lower surface of the second chromic layer (600).

In addition, the lithium-rich layer (700) is disposed on the electrolyte layer (800). The lithium-rich layer (700) may be adjacent to the upper surface of the electrolyte layer (800). The lithium-rich layer (700) may be in direct contact with the upper surface of the electrolyte layer (800).

That is, the lithium-rich layer (700) is disposed between the second chromic layer (600) and the electrolyte layer (800). The lithium-rich layer (700) may be sandwiched by the second chromic layer (600) and the electrolyte layer (800).

The lithium-rich layer (700) may include lithium hydroxide. The lithium-rich layer (700) may contain lithium at a high concentration. The lithium-rich layer (700) may be formed by combining lithium with electrochromic particles included in the second chromic layer (600). That is, the lithium-rich layer (700) may be formed by combining the second electrochromic material and lithium ions. That is, the lithium-rich layer (700) may include a compound of the second electrochromic material and lithium. The lithium-rich layer (700) may contain lithium at a higher concentration than the second chromic layer (600).

Furthermore, the lithium-rich layer (700) may contain lithium at a higher concentration than the electrolyte layer (800). In the lithium-rich layer (700), the concentration of lithium may be about 5 wt % to about 30 wt %, about 7 wt % to about 30 wt %, about 3 wt % to about 20 wt %, about 10 wt % to about 30 wt %, about 5 wt % to about 20 wt %, or about 3 wt % to about 15 wt %.

The concentration of lithium in the lithium-rich layer (700) may be greater than the concentration of lithium in the second chromic layer (600) by about 0.1 wt % to about 5 wt %, about 1 wt % to about 10 wt %, about 3 wt % to about 10 wt %, about 0.5 wt % to about 5 wt %, about 5 wt % to about 15 wt %, or about 0.1 wt % to about 10 wt %. The thickness of the lithium-rich layer (700) may be about 10 nm to about 1000 nm, about 1 nm to about 500 nm, about 1 nm to about 300 nm, about 1 nm to about 200 nm, about 100 nm to about 1000 nm, about 50 nm to about 500 nm, about 0.5 nm to about 500 nm, about 0.3 nm to about 30 nm, about 0.1 nm to about 10 nm, or about 1 nm to about 100 nm.

Since the lithium-rich layer (700) has the characteristics described above, the electrochromic device according to the embodiment may have improved discoloration speed and durability. In particular, the lithium-rich layer (700) may rapidly supply lithium to the second chromic layer (600) during the discoloration process. Accordingly, the electrochromic device according to the embodiment may have improved discoloration speed and durability. The second substrate (200), the second transparent electrode (400), the second chromic layer (600), and the lithium-rich layer (700) are included in a second laminate. That is, the second laminate includes the second substrate (200), the second transparent electrode (400), the second chromic layer (600), and the lithium-rich layer (700). The second laminate may be composed of the second substrate (200), the second transparent electrode (400), the second chromic layer (600), and the lithium-rich layer (700). The electrolyte layer (800) is disposed on the first chromic layer (500). In addition, the electrolyte layer (800) is disposed under the second chromic layer (600). The electrolyte layer (800) is disposed under the lithium-rich layer (700). The electrolyte layer (800) is positioned between the first chromic layer (500) and the lithium-rich layer (700).

The electrolyte layer (800) may include a solid polymer electrolyte containing metal ions, an inorganic hydrate, or the like. The electrolyte layer (800) may include lithium ions (Li+), sodium ions (Na+), potassium ions (K+), and the like.

Specifically, the solid polymer electrolyte may include Poly-AMPS, PEO/LiCF3SO3, and the inorganic hydrate may include Sb2O5·4H2O.

Furthermore, the electrolyte layer (800) is configured to provide electrolyte ions involved in the electrochromic reaction. The electrolyte ions may be monovalent cations, such as H+, Lit, Na+, K+, Rb+, or Cs+, for example.

The electrolyte layer (800) may include an electrolyte. Examples of the electrolyte include, without limitation, a liquid electrolyte, a gel polymer electrolyte, or an inorganic solid electrolyte. Furthermore, the electrolyte may be used in the form of a single layer or film so as to be laminated with the electrode or substrate.

The type of electrolyte salt used in the electrolyte layer (800) is not particularly limited, as long as it can include a compound capable of providing a monovalent cation, i.e., H+, Li+, Na+, K+, Rb+, or Cs+. For example, the electrolyte layer (800) may include a lithium salt compound, such as LiClO4, LiBF4, LiAsF6, LiPF6, LiCl, LiBr, LiI, LiB10Cl10, LiCF3SO3, LiCF3CO2, LiAsF6, LiSbF6, LiAlCl4, CH3SO3Li, CF3SO3Li, or (CF3SO2)2NLi; or a sodium salt compound, such as NaClO4. In one example, the electrolyte layer (800) may include a Cl or F element-containing compound as an electrolyte salt. Specifically, the electrolyte layer (800) may include one or more electrolyte salts selected from LiClO4, LiBF4, LiAsF6, LiPF6, LiCl, LiB10Cl10, LiCF3SO3, LiCF3CO2, LiAsF6, LiSbF6, LiAlCl4, CF3SO3Li, (CF3SO2)2NLi, and NaClO4.

The electrolyte may further include a carbonate compound as a solvent. Carbonate compounds have a high dielectric constant, and thus can increase ionic conductivity. As non-limiting examples, solvents such as propylene carbonate (PC), ethylene carbonate (EC), dimethyl carbonate (DMC), diethyl carbonate (DEC), or ethylmethyl carbonate (EMC) may be used as the carbonate compound. In another example, when the electrolyte layer (800) includes a gel polymer electrolyte, the electrolyte layer (800) may be polyvinyl sulfonic acid, polystyrene sulfonic acid, polyethylene sulfonic acid, poly-2-Poly-2-acrylamido-2methyl-propane sulfonic acid, Poly-perfluoro sulfonic acid, Poly-toluene sulfonic acid, Poly-vinyl alcohol, Poly-ethylene imine, Poly-vinyl pyrrolidone, Poly-ethylene oxide (PEO), Poly-propylene oxide (PPO), Poly-(ethylene oxide, siloxane) (PEOS), Poly-(ethylene glycol, siloxane) (poly-(ethylene glycol, siloxane)), Poly-(propylene oxide, siloxane) (poly-(ethylene oxide, methyl The electrolyte layer (800) may include a polymer such as poly(ethylene oxide, methyl methacrylate) (PEO-PMMA)), poly(ethylene oxide, acrylic acid) (PEO PAA)), poly(propylene glycol, methyl methacrylate) (PPG PMMA)), poly-ethylene succinate, or poly-ethylene adipate. In one example, a mixture of two or more of the above-listed polymers or a copolymer of two or more may be used as the polymer electrolyte.

In addition, the electrolyte layer (800) may include a curable resin that can be cured by ultraviolet irradiation or heat. The curable resin may be at least one selected from the group consisting of an acrylate oligomer, a polyethylene glycol oligomer, a urethane oligomer, a polyester oligomer, polyethylene glycol dimethyl, or polyethylene glycol diacrylate. In addition, the electrolyte layer (800) may include a photocuring initiator and/or a thermal curing initiator.

The thickness of the electrolyte layer (800) may be about 10 μm to about 200 μm. The thickness of the electrolyte layer (800) may be about 50 μm to about 150 μm.

The electrolyte layer (800) may have a transmittance within a range of 60% to 95%. Specifically, the electrolyte layer (800) may have a transmittance within a range of 60% to 95% for visible light having a wavelength of 380 nm to 780 nm, more specifically, a wavelength of 400 nm or 550 nm. The transmittance may be measured using a known haze meter (HM). The electrochromic device according to the embodiment may further include a sealing member (not shown).

The sealing member includes a curable resin. The sealing member may be heat-cured. It may include a curable resin and/or a photocurable resin.

Examples of the thermosetting resin include epoxy resin, melamine resin, urea resin, or unsaturated polyester resin. Furthermore, examples of the epoxy resin include phenol novolac-type epoxy resin, cresol novolac-type epoxy resin, biphenyl novolac-type epoxy resin, trisphenol novolac-type epoxy resin, dicyclopentadiene novolac-type epoxy resin, bisphenol A-type epoxy resin, bisphenol F-type epoxy resin, 2,2′-diarylbisphenol A-type epoxy resin, bisphenol S-type epoxy resin, hydrogenated bisphenol A-type epoxy resin, propylene oxide-added bisphenol A-type epoxy resin, biphenyl-type epoxy resin, naphthalene-type epoxy resin, resorcinol-type epoxy resin, or glycidyl amines.

Furthermore, the sealing member may further include a thermosetting agent. 1, 3-Bis[hydrazinocarbonoethyl 5-isopropyl hydantoin], hydrazide compounds such as adipic acid dihydrazide; dicyandiamide, guanidine derivatives, 1-cyanoethyl-2-phenyl imidazole, N-[2-(2-methyl-1-imidazolyl) ethyl]urea, 2,4-diamino-6-[2′-methylimidazolyl(1′)]-ethyl-s-thoriazine, N,N′-bis(2-methyl-1-imidazolyl ethyl) urea, N,N′-(2-methyl-1-imidazolyl ethyl)-azipoamido, 2-phenyl-4-methyl-5-hydroxymethyl imidazole, 2-imidazoline-2-thiol, 2,2′-thio-zinc Examples thereof include ethanethiol, adducts of various amines and epoxy resins, etc.

The first sealing member may include a photocurable resin. Examples of the photocurable resin include acrylate-based resins such as urethane acrylate. In addition, the sealing member may further include a photocuring initiator. The photocuring initiator may be at least one selected from the group consisting of acetophenone-based compounds, benzophenone-based compounds, thioxanthone-based compounds, benzoin-based compounds, triazine-based compounds, or oxime-based compounds.

In addition, the sealing member may further include a moisture absorbent such as zeolite and/or silica. In addition, the sealing member may further include an inorganic filler. The inorganic filler may be a material having high insulating properties, transparency, and durability. Examples of the inorganic filler include silicon, aluminum, zirconia, or mixtures thereof.

In addition, the electrochromic device according to the embodiment may further include a first bus bar (not shown) and a second bus bar (not shown).

The A first bus bar may be disposed on the first transparent electrode (300). The first bus bar may be connected to the first transparent electrode (300).

The first bus bar may be electrically connected to the first transparent electrode (300). The first bus bar may be in direct contact with the upper surface of the first transparent electrode (300). The first bus bar may be connected to the first transparent electrode (300) via solder.

The second bus bar is disposed below the second transparent electrode (400). The second bus bar is connected to the second transparent electrode (400).

The second bus bar may be electrically connected to the second transparent electrode (400). The second bus bar may be in direct contact with the lower surface of the second transparent electrode (400). The second bus bar may be connected to the second transparent electrode (400) via solder. The first bus bar and/or the second bus bar may include a metal. The first bus bar and/or the second bus bar may include a metal ribbon. The first bus bar and/or the second bus bar may include a conductive paste. The first bus bar and/or the second bus bar may include a binder and a conductive filler.

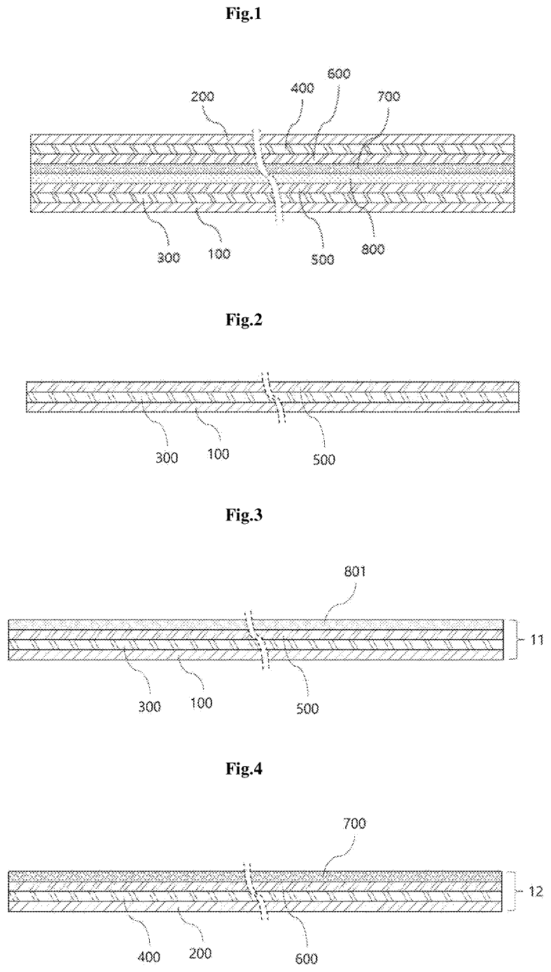

An electrochromic device according to an embodiment may be manufactured by the following method. FIGS. 2 to 5 are cross-sectional views illustrating a process for manufacturing an electrochromic device according to an embodiment.

Referring to FIG. 2, a first transparent electrode (300) is formed on a first substrate (100). The first transparent electrode (300) may be formed by a vacuum deposition process.

A metal oxide such as indium tin oxide is deposited on the first substrate (100) by a sputtering process, etc., thereby forming the first A transparent electrode (300) may be formed.

The first transparent electrode (300) may be formed by a coating process. Nano metal wires may be coated on the first substrate (100) together with a binder, thereby forming the first transparent electrode (300). A conductive polymer may be coated on the first substrate (100), thereby forming the first transparent electrode (300).

In addition, the first transparent electrode (300) may be formed by a patterning process. A metal layer may be formed on the first substrate (100) by a sputtering process or the like, and the metal layer may be patterned, thereby forming a first transparent electrode (300) layer including a metal mesh on the first substrate (100).

Thereafter, a first chromic layer (500) is formed on the first transparent electrode (300) layer. The first chromic layer (500) may be formed by a sol-gel coating process. A first sol solution including a first electrochromic material, a binder, and a solvent may be coated on the first transparent electrode (300) layer. A sol-gel reaction may occur in the coated first sol solution, and the first chromic layer (500) can be formed.

The first sol solution can contain the first electrochromic material in particle form in an amount of about 5 wt % to about 30 wt % based on the total weight of the solution. The first sol solution can contain the binder in an amount of about 0.5 wt % to about 5 wt % based on the total weight of the solution. The first sol solution can contain the solvent in an amount of about 70 wt % to about 95 wt % based on the total weight of the solution.

The first sol solution can further include a dispersant.

The solvent can be at least one selected from the group consisting of alcohols, ethers, ketones, esters, or aromatic hydrocarbons. One or more solvents may be selected. The solvent may be at least one selected from the group consisting of ethanol, propanol, butanol, hexanol, cyclohexanol, diacetone alcohol, ethylene glycol, diethylene glycol, glycerin, diethyl ether, ethylene glycol monomethyl ether, ethylene glycol monoethyl ether, ethylene glycol monobutyl ether, diethylene glycol monomethyl ether, diethylene glycol monoethyl ether, propylene glycol monomethyl ether, acetone, methyl ethyl ketone, acetylacetone, methyl isobutyl ketone, cyclohexanone, acetoacetic acid ester, methyl acetate, ethyl acetate, n-propyl acetate, and i-butyl acetate.

The binder may be an inorganic binder, as described above.

Thereafter, an electrolyte composition for forming an electrolyte layer (800) is formed.

The electrolyte composition may include a metal salt, It may include an electrolyte, a photocurable resin, and a photocurable initiator. The photocurable resin The polymer may be selected from the group consisting of hexandiol diacrylate (HDDA), tripropyleneglycoldiacrylate (TPGDA), ethyleneglycoldiacrylate (EGDA), trimethylolpropane triacrylate (TMPTA), trimethylolpropane ethoxylated triacrylate (TMPEOTA), glycerol propoxylated triacrylate (GPTA), pentaerythritol tetraacrylate (PETA), or dipentaerythritol hexaacrylate (DPHA). The metal salt, the electrolyte, and the photocuring initiator may be as described above.

Referring to FIG. 3, the electrolyte composition is coated on the first chromic layer (500). Accordingly, an electrolyte composition coating layer (801) is formed on the first chromic layer (500).

Referring to FIG. 4, a second transparent electrode (400) is formed on a second substrate (200).

The second transparent electrode (400) may be formed by a vacuum deposition process. A metal oxide, such as indium tin oxide, may be deposited on the second substrate (200) by a sputtering process, thereby forming the second transparent electrode (400).

The second transparent electrode (400) may be formed by a coating process. The second transparent electrode (400) may be formed by coating nano-metal wires with a binder on the second substrate (200). The second transparent electrode (400) may be formed by coating a conductive polymer on the second substrate (200).

Furthermore, the second transparent electrode (400) may be formed by a patterning process. A metal layer may be formed on the second substrate (200) by a sputtering process or the like, and the metal layer may be patterned to form a second transparent electrode (400) layer including a metal mesh on the second substrate (200).

Thereafter, a second chromic layer (600) is formed on the second transparent electrode (400) layer. The second chromic layer (600) may be formed by a sol-gel coating process. A second sol solution containing a second electrochromic material, a binder, and a solvent may be coated on the second transparent electrode (400) layer. A sol-gel reaction may occur in the coated second sol solution, forming the second chromic layer (600).

The second sol solution may contain the second chromic material in particle form in an amount of about 5 wt % to about 30 wt % based on the total solution weight. The second sol solution may contain the binder in an amount of about 0.5 wt % to about 5 wt % based on the total solution weight. The second sol solution may contain the solvent in an amount of about 70 wt % to about 95 wt % based on the total solution weight.

The second sol solution may additionally contain a dispersant.

Thereafter, the lithium-rich layer (700) is formed on the second chromic layer (600). To form the lithium-rich layer (700), a lithium hydroxide aqueous solution is prepared. The lithium hydroxide aqueous solution includes deionized water and lithium hydroxide. The lithium hydroxide can be uniformly dissolved in the deionized water.

In the lithium hydroxide aqueous solution, the concentration of lithium hydroxide may range from about 0.01 wt % to about 5 wt %.

The lithium hydroxide aqueous solution is then coated entirely on the second chromic layer (600).

Then, the deionized water contained in the coated lithium hydroxide aqueous solution is dried, and the lithium-rich layer (700) can be formed on the second chromic layer (600).

Furthermore, the second laminate (12) on which the lithium-rich layer (700) is formed can be heat-treated at a temperature of about 60° C. to about 150° C. for about 5 to about 60 minutes. When the second laminate (12) on which the lithium-rich layer (700) is formed is heat-treated, lithium contained in the lithium-rich layer (700) can diffuse into the second chromic layer (600).

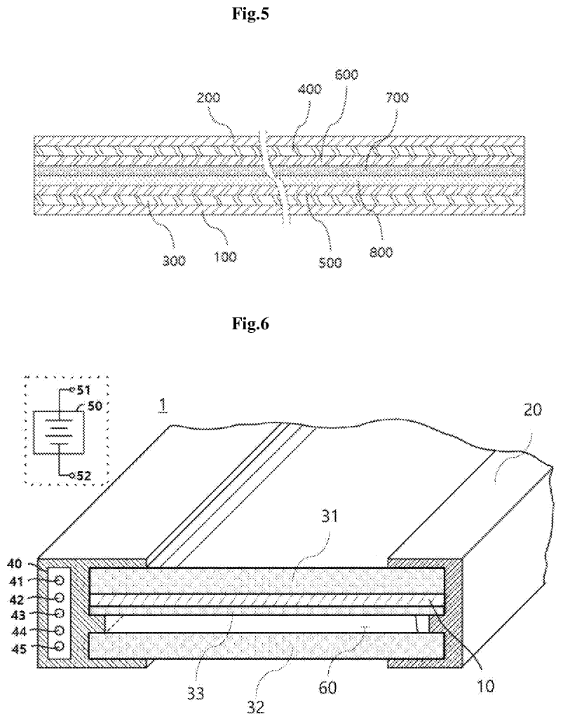

Referring to FIG. 5, the second substrate (200), the second transparent electrode (400), the second chromic layer (600), and the lithium-rich layer (700) are laminated on the coated electrolyte composition layer (801). That is, the second laminate (12) can be laminated on the coated electrolyte composition layer. At this time, the lithium-rich layer (700) is in direct contact with the coated electrolyte composition layer (801). Thereafter, the coated electrolyte composition layer (801) is cured by light, and a first laminate (11) including the first substrate (100), the first transparent electrode (300), and the first chromic layer (500) and a second laminate (12) including the second substrate (200), the second transparent electrode (400), and the second chromic layer (600) are laminated to each other. That is, the first laminate (11) and the second laminate (12) can be adhered to each other by the electrolyte layer (800).

Therefore, an electrochromic device according to an embodiment can be manufactured.

In addition, the electrochromic device according to an embodiment can have light transmittance. Here, the light transmittance can mean light transmittance based on a state in which the electrochromic device is not electrochromic. In addition, the light transmittance can mean total light transmittance. The light transmittance of the electrochromic device may be about 50% to about 90%. The light transmittance of the electrochromic device may be about 55% to about 88%. The light transmittance of the electrochromic device may be about 68% to about 86%.

The electrochromic device according to the embodiment has a lithium-rich layer (700). Accordingly, the electrochromic device according to the embodiment can improve the movement speed of lithium ions during operation. That is, the lithium-rich layer (700) can rapidly supply lithium ions to the second chromic layer (600), thereby causing the second chromic layer (600) to discolor or color.

Furthermore, the second chromic layer (600) can have an increasingly higher lithium concentration as it approaches the lithium-rich layer (700). Accordingly, the electrochromic device according to the embodiment can improve the speed of discoloration or coloration in the early stages of discoloration or coloration. Furthermore, since the second chromic layer (600) is adjacent to the lithium-rich layer (700), the second chromic layer (600) can contain lithium ions at a high concentration. That is, the second chromic layer (600) can accommodate lithium ions at a high concentration.

Therefore, the second chromic layer (600) can be discolored or colored to have an appropriate color and appropriate transmittance.

Therefore, the electrochromic device according to the embodiment can have improved the speed and performance of coloration or discoloration.

Furthermore, since the lithium contained in the lithium-rich layer (700) gradually diffuses into the second chromic layer (600), the electrochromic device according to the embodiment can easily color and decolorize the second chromic layer (600).

Therefore, the electrochromic device according to the embodiment can mitigate the chemical impact applied to the second chromic layer (600) during the coloring and/or decoloring process. Accordingly, the electrochromic device according to the embodiment can reduce operating time, reduce discoloration shock, and have improved durability.

FIG. 6 is a drawing illustrating a window device (1) according to the embodiment.

Referring to FIG. 6, the window device (1) according to the embodiment includes the electrochromic device (10), a frame (20), windows (31, 32, 33), a plug-in component (40), and a power supply (50).

The frame (20) may be composed of one or more pieces. For example, the frame (20) may be composed of one or more materials, such as vinyl, PVC, aluminum (Al), steel, or fiberglass. The frame (20) secures the windows (31, 32, 33) and seals the space between the windows (31, 32, 33). In addition, the frame (20) may hold or include pieces of foam or other materials. The frame (20) includes a spacer, which can be positioned between adjacent windows (31, 32, 33). Furthermore, the spacer, together with an adhesive sealant, can hermetically seal the space between the windows (31, 32, 33). The windows (31, 32, 33) are fixed to the frame (20). The windows (31, 32, 33) may be glass panes. The windows (31, 32, 33) may be conventional silicon oxide (SOx)-based glass substrates, such as soda lime glass or float glass, which are composed of approximately 75% silica (SiO₂) plus Na₂O, CaO, and some minor additives. However, any material having suitable optical, electrical, thermal, and mechanical properties may be used. The windows (31, 32, 33) may also include, for example, other glass materials, plastics and thermoplastic resins (e.g., poly(methyl methacrylate), polystyrene, polycarbonate, allyl diglycol carbonate, SAN (styrene acrylonitrile copolymer), poly(4-methyl-1-pentene), polyester, polyamide), or mirror materials. The windows (31, 32, 33) may include tempered glass.

The windows (31, 32, 33) may include a first window (31), a second window (32), and a third window (33). The first window (31) and the third window (33) may be arranged at the outermost portion, and the second window (32) may be arranged between the first window (31) and the third window (33). The electrochromic device (10) is placed between the first window (31) and the second window (32). The electrochromic device The first window (31) and the second window (32) may be laminated to the electrochromic device (10). The electrochromic device (10) may be laminated to the first window (31) by a first polyvinyl butyral sheet. That is, the first polyvinyl butyral sheet may be disposed on the first window (31) and the electrochromic device (10), and may be laminated to the first window (31) and the electrochromic device (10).

The electrochromic device (10) may be laminated to the second window (32) by a second polyvinyl butyral sheet. That is, the second polyvinyl butyral sheet may be disposed on the second window (32) and the electrochromic device (10), and may be laminated to the second window (32) and the electrochromic device (10). A space (60) may be formed between the second window (32) and the third window (33). The space may be filled with one or more gases, such as argon (Ar), krypton (Kr), or xenon (Xn). The windows (31, 32, 33) may be glass panes sized for residential or commercial window applications. The size of the glass panes may vary widely depending on the specific needs of the home or commercial enterprise. In some embodiments, the windows (31, 32, 33) may be formed of architectural glass. Architectural glass is typically used in commercial buildings, but may also be used in residential buildings, typically, but not necessarily, to separate the indoor environment from the outdoor environment. In some embodiments, a suitable architectural glass substrate may be at least about 20 inches by about 20 inches, and may be significantly larger, for example, about 80 inches by about 120 inches, or larger. Architectural glass is typically at least about 2 millimeters (mm) thick and can be as thick as 6 mm or more.

In some embodiments, the windows (31, 32, 33) can have a thickness in the range of about 1 mm to about 10 mm.

In some embodiments, the windows (31, 32, 33) can be very thin and flexible, such as Gorilla Glass® or Willow™ Glass, each of which are commercially available from Corning, Inc. of New York, Corning, and which can have a thickness of less than 0.3 mm or less than about 1 mm.

The plug-in component (40) can include a first electrical input (41), a second electrical input (42), a third electrical input (43), a fourth electrical input (44), and a fifth electrical input (45). Additionally, the power supply unit (50) includes a first power terminal (51) and a second power terminal (52).

The first electrical input (41) is electrically coupled to the first power terminal (51) via one or more wires or other electrical connections, components, or devices.

The first electrical input (41) may include a pin, a socket, or other electrical connector or conductor. Furthermore, the first electrical input (41) may be electrically connected to the electrochromic device (10) via a first bus bar (not shown). The first bus bar may be electrically connected to the second transparent electrode (400).

The second electrical input (42) is electrically coupled to the second power terminal (52) via one or more wires or other electrical connections, components, or devices. The second electrical input (42) may include a pin, socket, or other electrical connector or conductor. Furthermore, the second electrical input (42) may be electrically connected to the electrochromic device (10) via a second bus bar (not shown). The second bus bar may be electrically connected to the first transparent electrode (300).

The third electrical input (43) may be coupled to a device, system, or building ground.

The fourth electrical input (44) and the fifth electrical input (45) may be individually used for communication between, for example, a controller or microcontroller controlling the Windows device (1) and a network controller.

The power supply (50) supplies power to the electrochromic device (10) via the plug-in component (40). In addition, the power supply unit (50) can be controlled by an external controller to supply power of a predetermined waveform to the electrochromic device (10).

In addition, the features, structures, effects, etc. described in the embodiments above are included in at least one embodiment of the present invention, and are not necessarily limited to just one embodiment. Furthermore, the features, structures, effects, etc. exemplified in each embodiment can be combined or modified to implement other embodiments by those skilled in the art to which the embodiments pertain. Therefore, the contents related to such combinations and modifications should be construed as being included within the scope of the present invention.

While the embodiments have been described above, these are merely examples and do not limit the present invention. Those skilled in the art will appreciate that various modifications and applications not exemplified above are possible without departing from the essential characteristics of the embodiments. For example, each component specifically illustrated in the embodiments can be modified and implemented. And the differences related to these modifications and applications should be construed as being included within the scope of the present invention as defined in the appended claims.

### MANUFACTURING EXAMPLE

ITO Film: Hansung Industrial, HI150-ABE-125A-AB
Tungsten Oxide Powder Dispersion: Adchro, ELACO-W
Nickel Oxide Powder Dispersion: Adchro, ELACO-N
Lithium Hydroxide Aqueous Solution: Formed by dissolving lithium hydroxide (Duksan Chemical) in deionized water at a concentration of approximately 0.1 wt %
Gel Polymer Electrolyte Composition

A gel polymer electrolyte composition was prepared by mixing approximately 39 parts by weight of dipentaerythritol hexaacrylate (DPHA), approximately 5 parts by weight of the ionic liquid 1-butyl-3-methylimidazolium bis(trifluoromethanesulfonyl)imide [BMI-TFSI], and approximately 1 part by weight of diethoxyacetophenone (DEAP). LiBF4 (Li+ concentration: 1 mol/L) was added.

### Example 1

A first chromic material composition was prepared by uniformly mixing about 10 parts by weight of tungsten oxide powder, about 1 part by weight of TEOS, and about 90 parts by weight of ethanol. The first chromic material composition was coated on a first ITO film to a thickness of about 25 μm, and a first chromic layer having a thickness of about 600 nm was formed through a sol-gel reaction at a temperature of about 110° C. for about 5 minutes.

A second chromic material composition was prepared by uniformly mixing about 11 parts by weight of nickel oxide powder, about 1 part by weight of TEOS, and about 89 parts by weight of ethanol. The second chromic material composition was coated on a second ITO film to a thickness of about 40 μm, and a second chromic layer having a thickness of 1200 nm was formed through a sol-gel reaction at a temperature of about 120° C. for about 5 minutes. Thereafter, a lithium hydroxide aqueous solution was coated on the second chromic layer to a thickness of approximately 4 μm, and drying was performed at a temperature of approximately 120° C. for approximately 5 minutes, forming a lithium-rich layer having a thickness of approximately 0.005 μm. Accordingly, a second laminate comprising the second ITO film, the second chromic layer, and the lithium-rich layer was manufactured. The gel polymer electrolyte composition was coated on the first chromic layer to a thickness of approximately 100 μm, and the second ITO film, on which the second chromic layer was formed, was laminated onto the coated gel polymer electrolyte composition, and the coated gel polymer electrolyte composition was cured using UV light. The laminate was then left at room temperature for approximately 14 hours for aging. Thus, an electrochromic device according to the embodiment was manufactured.

### Examples 2 to 4 and Comparative Examples

As shown in Table 1 below, the concentration of the lithium hydroxide aqueous solution was adjusted, and the lithium-rich layer was formed.

TABLE 1

| | Lithium hydroxide | Thickness of |
|---|---|---|
| | aqueous solution | lithium-rich |
| classification | concentration (wt %) | layer(μm) |
| Example 1 | 0.1 | 0.005 |
| Example 2 | 0.2 | 0.01 |
| Example 3 | 0.3 | 0.015 |
| Example 4 | 0.4 | 0.02 |
| Example 5 | 0.5 | 0.025 |
| Comparative | — | 0 |
| example | | |

### EVALUATION EXAMPLE

### 1. Coloring Speed

The electrochromic devices (5 cm×5 cm) manufactured in the Examples and Comparative Examples were colored by a driving voltage of 1.5 V, and then discolored for a sufficient period of time. Thereafter, the electrochromic devices manufactured in the Examples and Comparative Examples were colored again by the driving voltage, and the time until they had a total light transmittance of approximately 15% was measured. The total light transmittance was measured using a solar spectrum meter (ED™, SS2450) in the wavelength range of approximately 380 nm to approximately 780 nm.

### 2. Charge-Discharge Test

The electrochromic devices manufactured in the Examples and Comparative Examples were placed in a solar simulator and exposed to simulated sunlight. The (−) electrode of a charge-discharge tester (Won-A Tech, WBCS_D70714K1) was connected to a bus bar attached to tungsten oxide, and the (+) electrode was connected to a bus bar attached to nickel oxide. Then, a predetermined voltage was applied to reach a sufficiently high discoloration transmittance. Then, the voltages were reversed due to internal electrical modifications within the charge-discharge tester, with the (+) voltage applied to the bus bar connected to tungsten oxide and the (−) voltage applied to the bus bar connected to nickel oxide. This was adjusted so that a sufficiently low discoloration transmittance was reached. This was considered one cycle. The charge-discharge test was conducted by repeatedly measuring the transmittance and charge-discharge capacity. The number of cycles during which the discoloration range remained constant and the charge-discharge capacity remained above 80% was measured. As shown in Table 2 below, the coloring speed and charge/discharge cycles were measured in the electrochromic devices according to the examples and comparative examples.

TABLE 2

| | Coloring | Number of |
|---|---|---|
| | speed | charge/discharge |
| classification | (seconds) | cycles |
| Example 1 | 62 | 20000 |
| Example 2 | 46 | 19500 |
| Example 3 | 31 | 20000 |
| Example 4 | 23 | 19900 |
| Example 5 | 15 | 20000 |
| Comparative | 180 | 19800 |
| example | | |

As described in Table 2 above, the electrochromic devices according to the embodiments had improved durability and coloring or discoloring speed.

What is claimed:

1. An electrochromic device comprising:
a first substrate;
a first transparent electrode disposed on the first substrate;
a first chromic layer disposed on the first transparent electrode;
an electrolyte layer disposed on the first chromic layer;
a second chromic layer disposed on the electrolyte layer;
a second transparent electrode disposed on the second chromic layer;
a second substrate disposed on the second transparent electrode; and
a lithium-rich layer disposed under and adjacent to the second chromic layer,
wherein the lithium-rich layer contains lithium at a higher concentration than the second chromic layer.

2. The electrochromic device according to claim 1, wherein the lithium concentration of the second chromic layer gradually decreases as the second chromic layer approaches the second transparent electrode from the lithium-rich layer.

3. The electrochromic device according to claim 1, wherein the lithium-rich layer comprises lithium hydroxide.

4. The electrochromic device according to claim 1, wherein the first substrate and the second substrate are flexible.

5. The electrochromic device according to claim 1, wherein the lithium-rich layer has a thickness of 10 nm to 1000 nm.

6. The electrochromic device according to claim 3, wherein the first chromic layer comprises tungsten oxide and the second chromic layer comprises nickel oxide.

7. An electrochromic device according to claim 1, wherein the lithium concentration of the lithium-rich layer is 3 to 30 times higher than the lithium concentration of the second chromic layer.

8. A method for manufacturing an electrochromic device, comprising:
preparing a first laminate comprising a first substrate, a first transparent electrode on the first substrate and a first chromic layer on the first transparent electrode;
preparing a second laminate comprising a second substrate, a second transparent electrode on the second substrate, a second chromic layer on the second transparent electrode and a lithium-rich layer on the second chromic layer;
bonding the first laminate and the second laminate via an electrolyte layer, wherein the lithium-rich layer contains lithium at a higher concentration than the second chromic layer.

9. The method for manufacturing an electrochromic device according to claim 8, wherein the step of preparing the second laminate comprises coating lithium hydroxide on the second chromic layer.

10. The method for manufacturing an electrochromic device according to claim 9, wherein the step of preparing the second laminate further comprises heat-treating the lithium hydroxide.

11. The method for manufacturing an electrochromic device according to claim 10, wherein the lithium concentration in the second chromic layer gradually decreases as the second chromic layer approaches the second transparent electrode from the lithium-rich layer.

12. The method for manufacturing an electrochromic device according to claim 10, wherein in the step of heat-treating the lithium hydroxide, lithium contained in the lithium hydroxide diffuses into the second chromic layer.

13. A method for manufacturing an electrochromic device according to claim 12, wherein the lithium concentration of the lithium-rich layer is 3 to 30 times higher than the lithium concentration of the second chromic layer.

14. A window device comprising:
a frame;
a window mounted to the frame; and
an electrochromic device disposed in the window,
the electrochromic device comprising:
a first substrate;
a first transparent electrode disposed on the first substrate;
a first chromic layer disposed on the first transparent electrode;
an electrolyte layer disposed on the first chromic layer;
a second chromic layer disposed on the electrolyte layer;
a second transparent electrode disposed on the second chromic layer;
a second substrate disposed on the second transparent electrode; and
a lithium-rich layer disposed beneath and adjacent to the second chromic layer,
wherein the lithium-rich layer contains a higher lithium concentration than the second chromic layer.

15. The window device according to claim 14, wherein the lithium concentration of the second chromic layer gradually decreases as the second chromic layer approaches the second transparent electrode from the lithium-rich layer.

16. The window device according to claim 14, wherein the lithium-rich layer comprises lithium hydroxide.

17. The window device according to claim 14, wherein the first substrate and the second substrate are flexible.

18. The window device according to claim 14, wherein the lithium-rich layer has a thickness of 10 nm to 1000 nm.

19. The window device according to claim 16, wherein the first chromic layer comprises tungsten oxide and the second chromic layer comprises nickel oxide.

20. The window device according to claim 14, wherein the lithium concentration of the lithium-rich layer is 3 to 30 times higher than the lithium concentration of the second chromic layer.
